(19) United States
(12) Patent Application Publication
(10) Pub. No.: US 2005/0211742 A1
(43) Pub. Date: Sep. 29, 2005

(54) Post-mounted storage caddy

(76) Inventors: Shawn L. Mapes, Ocala, FL (US); Dennis E. Machie, Ocala, FL (US)

Correspondence Address: CLARK & BRODY, 1090 VERMONT AVENUE, NW, SUITE 250, WASHINGTON, DC, 20005, US

(21) Appl. No.: 11/039,928

(22) Filed: Jan. 24, 2005

Related U.S. Application Data
(60) Provisional application No. 60/538,232, filed on Jan. 23, 2004.

(51) Int. Cl. B62B 1/00

(52) U.S. Cl. 224/406

(57) ABSTRACT

A post-mounted storage caddy comprises a caddy body adapted to be mounted to a post, and especially a seat post in a boat. A storage tray with compartments is pivotally mounted to the caddy body, whereby the caddy body functions as a lid for the storage caddy. The storage caddy can also include a cup holder and other holding means.

This application claims priority under 35 USC 119(e) based on application Ser. No. 60/538,232 filed on Jan. 23, 2004.

### FIELD OF THE INVENTION

The present invention relates to a storage caddy that is adapted for seats that are post-mounted, and especially seats such as those found in bass boats.

### BACKGROUND ART

In the prior art, bass boats are known to have seats mounted on posts to permit the fisherman to sit at an elevated spot while fishing. However, while a fisherman sits on these seats, various items that come in handy for fishing are generally not within easy reach. Consequently, the fisherman has to interrupt his fishing by leaving the seat to get an item such as a pair of pliers, another fishing rod, a drink or the like.

As such, a need exists for improved accessibility to items that would be used by a fisherman when perched on a seat in a fishing boat. The present invention responds to this need by providing a storage caddy that mounts beneath a post-mounted seat and provides the fisherman with receptacles for holding items and storage capacity.

### SUMMARY OF THE INVENTION

A first object of the invention is a storage caddy adapted to be used with a post.

Another object of the invention is a storage caddy that is adapted to attach to a post-mounted seat on a fishing boat.

A further object of the present invention is a combination seat-post and storage caddy.

Other objects and advantages will become apparent when reviewing the description below.

In satisfaction of the foregoing objects and advantages, the present invention provides a post-mounted storage caddy that is preferably adapted for use on a boat. The storage caddy has a caddy body that includes means to mount the caddy body to a post. A storage tray is provided that has a number of compartments, the tray being pivotally attached to the caddy body such that rotation of the storage tray exposes the compartments for use. If desired, the caddy can include a cup holder adapted to be mounted to the caddy body. Another option for the caddy is one or more holders extending from an end of the caddy body for retaining items such as fishing equipment or the like. The holders are preferably configured with through openings and a slot in the wall that forms the through opening.

While the storage tray and caddy can be mounted together in any way that would allow the tray to pivot with respect to the caddy body, a preferred manner of attachment includes providing a first opening in one end of the caddy body. The caddy body is equipped with a number of flexible tabs, each with a lip on a free end thereof, the tabs adjacent the first opening and extending from an underside of the caddy body. The storage tray is provided with another opening in an end thereof. The tabs are angled and sized so that when first and second openings are aligned, and the cup holder is inserted into the aligned openings, the tabs are biased outwardly so that the tab lips catch an underside of the storage tray to keep it in place and allow it to rotate with respect to the caddy body for access to the compartments.

The invention also entails the combination of the storage caddy and a seat post and bracket. The storage caddy can be mounted to either the post, the bracket, or both if so desired. The seat post can be mounted virtually anywhere a seat is needed, with a preferred environment being a seat post on a fishing boat, e.g., a bass boat or the like.

### BRIEF DESCRIPTION OF THE DRAWINGS

FIG. 1 shows an exploded view of one embodiment of the invention;

FIG. 2 shows the storage caddy of FIG. 1 in an exemplary mounting with a post and a seat bracket;

FIG. 2a is a schematic showing the attachment of the storage caddy to the post-seat bracket arrangement.

FIG. 3 shows an exemplary use of the storage caddy of FIG. 1; and

FIGS. 4a and 4b show an exemplary pivot connection between the caddy body and storage tray of the storage caddy.

### DESCRIPTION OF THE PREFERRED EMBODIMENTS

The present invention is advantageous in providing storage capability that is close at hand, particularly when fishing. The present invention allows the storage of a drink if so desired, small items that can be stored in compartments, tools, fishing rods, etc. The inventive storage caddy is especially adapted for providing storage at a post that is used to support a seat on a fishing boat.

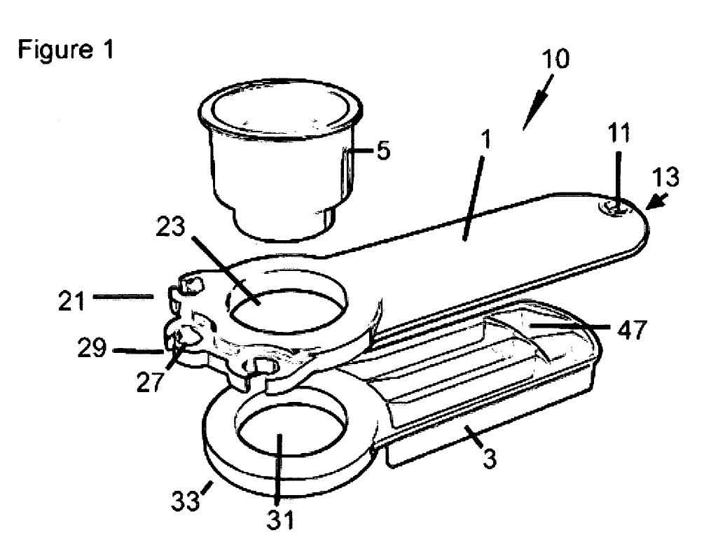

FIGS. 1-3 show an example of the inventive storage caddy. The caddy is designated by the reference numeral 10 and is seen to include a caddy body 1, and movable storage and securable tray 3 and a cup holder 5.

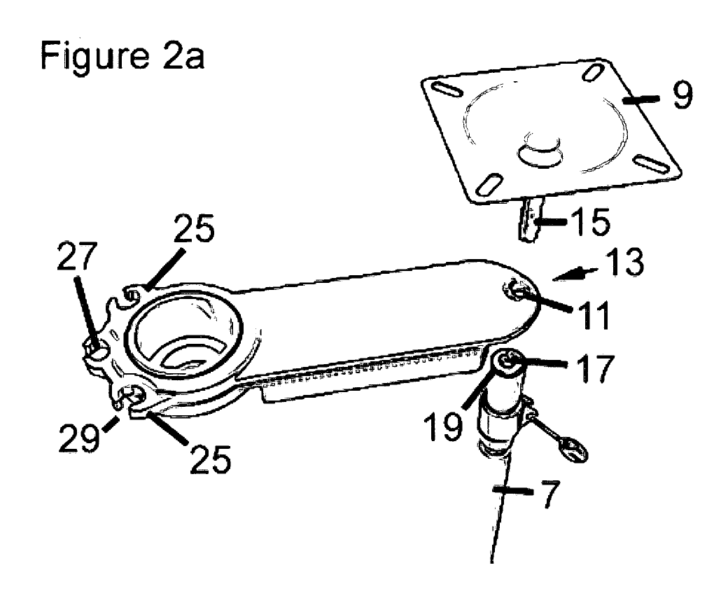

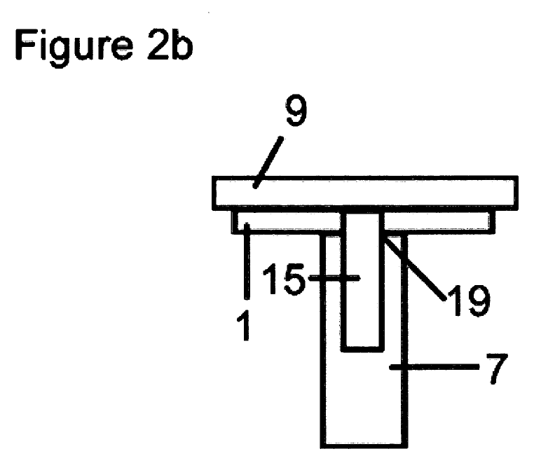

In FIG. 2, the caddy body 1 is adapted to be secured by association with a post 7 and seat bracket 9 as they would be found on a fishing boat. The caddy body 1 has an opening 11 on end 13. The opening 11 is sized to receive a bracket post 15 that extends from the seat bracket 9. The bracket post 15 is also sized to slip within an opening 17 in the post 7. With this arrangement, the caddy body 1 is sandwiched between an underside of the seat bracket 9 and a top edge 19 of the post 7, see FIG. 2a. The caddy body 1 can be pivoted to the desired location and the bracket post 15 secured to the post 7 in such a fashion to keep the caddy body 1 in its desired location. Loosening the connection would allow pivoting movement of the body 1 to another location. The caddy body 1 can be made in any configuration, with the elongated generally rectangular one shown in FIG. 1 as an example only.

Another end 21 of the caddy body 1 can have another opening 23, which is sized to receive the cup holder 5. The end 21 also has a number of c-shaped holders 25, each having an opening 27 and a slot 29. These holders are adapted to retain other fishing related items such as pliers, or other tools. The openings 27 allow for insertion of an item such as a screwdriver, or pliers' handles or the like. The slots 29 allow for insertion of items that could not be inserted through the opening 27, e.g., an elongated member such as a fishing rod. It should be understood that the c-shaped holders are exemplary, and one or more other shaped holders could be employed, or the caddy body 21 could be made without any holders at all.

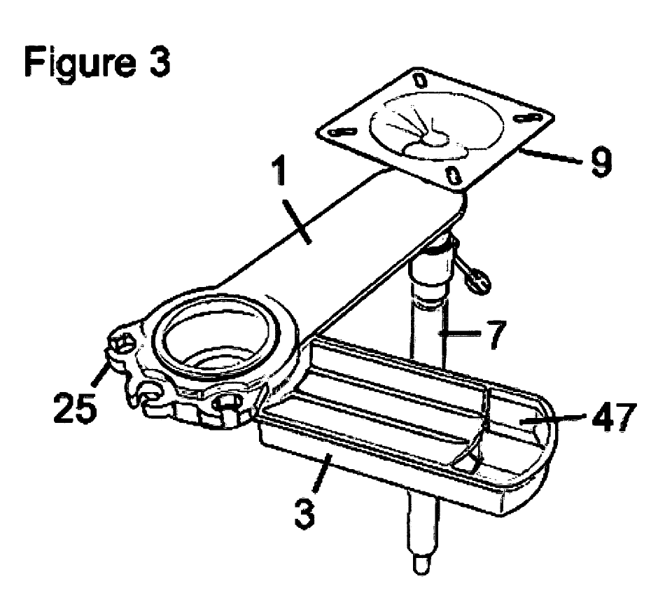

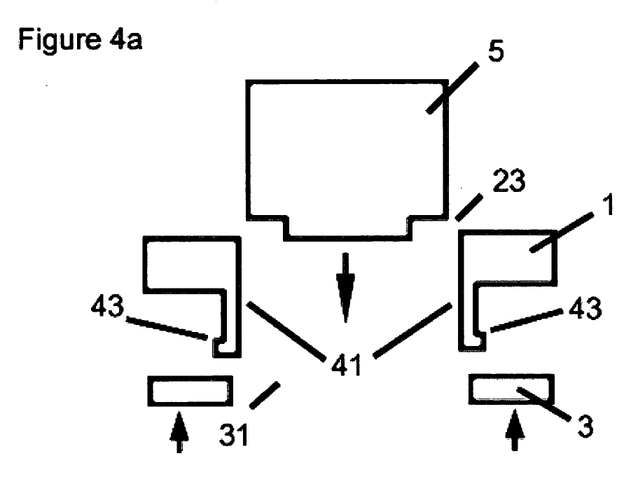

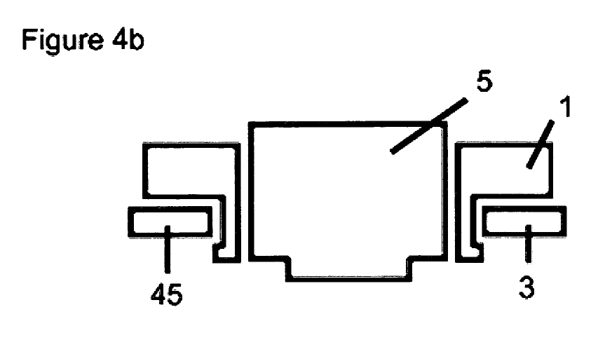

The storage tray 3 has an opening 31 on end 33. The opening 31 is sized to receive the cup holder 5, whereby the cup holder, in one embodiment, assists in the pivoting connection between the caddy body 1 and the storage tray 3. Referring now to FIGS. 4a and 4b and the pivot connection, the caddy body 1 includes a number of flexible tabs 41 extending from a bottom thereof and adjacent the opening 23. The tabs 41 terminate with a lip 43 that faces away from the center of the opening 23. The tabs 41 when at rest angle toward a center of the opening 23. This configuration allows the storage tray 3 to be moved into a position adjacent the caddy body 1, with opening 31 of the tray slipping around the tabs 41. At this stage, the storage tray 3 and caddy body could still be easily separated given the at-rest angulation of the tabs 41. When the cup holder 5 is inserted into opening 23 and opening 31, it biases the tabs 41 outwardly so that the lips 43 engage an underside 45 of the storage tray and keep the storage tray 3 in place with respect to the caddy body 1. While keeping the storage tray attached to the caddy body 1, it still allows the storage tray 3 to freely rotate as shown in FIG. 3.

Still referring to FIG. 3, the storage tray 3 also has a number of compartments 47 which can hold lures, bait or other fishing related items. Because the storage tray 3 can rotate so that the compartments 47 are disposed beneath the caddy body 1, there is no need for compartment covers. The storage tray when not in use can be rotated to the position shown in FIG. 2. Although not shown, a detent mechanism or some other securing mechanism could be employed between the ends 21 and 33 of the caddy body 1 and storage caddy 3 to hold the storage caddy in the positions shown in FIG. 3. Other locking mechanisms could be employed to ensure that when the storage caddy is rotated for access to the compartments, it stays in place until moved back to its stored position as shown in FIG. 2.

It should be understood that other means for retaining the storage tray 3 in place to allow for its rotation can be employed as part of the inventive caddy. Moreover, the inventive storage caddy can be used with other post and non-seat related structures where it could be mounted with a post for storage purposes.

While the caddy body 1 is shown sandwiched between the bracket and post in FIG. 2a, it could be attached to the post alone, or the bracket alone, or to both if so desired. Moreover, and although the cup holder 5 is integral to the pivotal connection between the caddy body and storage tray, the cup holder could be optional, and another means could be employed to link the two for pivoting movement of the storage caddy and access to the compartments 47. For example, the caddy body 1 could have spaced apart flexible tabs that would expand upon insertion of the storage tray end and then retract once the tray is inserted beyond the tab lips. Other modes of pivoting connections could be used as would be within the skill of the art.

The components of the storage caddy can be made of any materials, but are preferably made of polymers that would be resistant to the conditions encountered by fisherman.

As such, an invention has been disclosed in terms of preferred embodiments thereof which fulfills each and every one of the objects of the present invention as set forth above and provides a new and improved storage caddy designed for use with posts and particularly post-mounted seats, especially those seats found on fishing boats.

Of course, various changes, modifications and alterations from the teachings of the present invention may be contemplated by those skilled in the art without departing from the intended spirit and scope thereof. It is intended that the present invention only be limited by the terms of the appended claims.

1. A post-mounted storage caddy comprising:
a) a caddy body having means to mount the caddy body to a post; and
b) a storage tray having compartments, the storage caddy pivotally attached to the caddy body such that rotation of the storage tray exposes the compartments for use.

2. The caddy of claim 1, further comprising a cup holder adapted to be mounted to the caddy body.

3. The caddy of claim 1, further comprising one or more holders extending from an end of the caddy body for retaining items.

4. The caddy of claim 3, wherein at least one holder has a through opening and a slot formed in a wall that forms the through opening.

5. The caddy of claim 2, wherein the caddy body further comprises:
i) a first opening in one end sized to receive the cup holder;
ii) a number of flexible tabs, each with a lip on an free end thereof, the tabs adjacent the first opening and extending from an underside of the caddy body; and
wherein the storage tray has a second opening in an end thereof;
wherein the tabs are angled and sized so that when first and second openings are aligned, and the cup holder is inserted into the aligned openings, the tabs are biased outwardly so that the tab lips catch an underside of the storage tray to keep it in place and allow it to rotate with respect to the caddy body for access to the compartments.

6. A caddy and seat post combination comprising:
a) a seat post;
b) a seat bracket adapted to be mounted on the seat post;
c) a storage caddy mounted to one or both of the seat bracket and the seat post, the storage caddy further comprising:
i) a caddy body having means to mount the caddy body to a post; and
ii) a storage tray having compartments, the storage caddy pivotally attached to the caddy body such that rotation of the storage tray exposes the compartments for use.

7. The combination of claim 6, further comprising a cup holder adapted to be mounted to the caddy body.

8. The combination of claim 6, further comprising one or more holders extending from an end of the caddy body for retaining items.

9. The combination of claim 8, wherein at least one holder has a through opening and a slot formed in a wall that forms the through opening.

10. The combination of claim 6, wherein the caddy body further comprises:
i) a first opening in one end sized to receive the cup holder;
ii) a number of flexible tabs, each with a lip on an free end thereof, the tabs adjacent the first opening and extending from an underside of the caddy body; and
wherein the storage tray has a second opening in an end thereof;
wherein the tabs are angled and sized so that when first and second openings are aligned, and the cup holder is inserted into the aligned openings, the tabs are biased outwardly so that the tab lips catch an underside of the storage tray to keep it in place and allow it to rotate with respect to the caddy body for access to the compartments.

11. The combination of claim 8, wherein the seat posted is mounted in a boat.
